(19) United States
(12) Patent Application Publication
(10) Pub. No.: US 2026/0340063 A1
(43) Pub. Date: Oct. 29, 2026

(54) SYSTEM FOR TAKING OVER SERVICE AND CONTROL METHOD THEREFOR

(71) Applicant: CANON KABUSHIKI KAISHA, Tokyo (JP)

(72) Inventor: HISATOSHI YAMAZOE, Tokyo (JP)

(21) Appl. No.: 19/635,559

(22) Filed: Mar. 31, 2026

(30) Foreign Application Priority Data
Apr. 28, 2025 (JP) 2025-074859

(51) Int. Cl. G06F 16/955; H04L 41/085

(52) U.S. Cl. CPC G06F 16/9554; H04L 41/085

(57) ABSTRACT

A system provides a web page for supply of network devices on which whether to take over the services with which a first network device is registered is settable at the time of ordering a network device; generates takeover information in which a second network device ordered via the web page, the first network device, and a takeover type according to a setting indicating whether to take over the services are associated, to cause the takeover information to be registered with each of the services with which the first network device is registered; notifies each service capable of being provided to the second network device of registration of the second network device when the second network device is registered in a management server; and executes, in the service receiving the notification, takeover processing for the service based on the takeover information corresponding to the second network device.

### BACKGROUND

### Field of the Invention

The present disclosure relates to a system for taking over services upon device replacement and a control method therefor.

### Description of the Related Art

With the development and widespread adoption of the Internet of Things (hereinafter, “IoT”) and cloud services, it has become easier than before for various “things” to transmit data to a cloud server via the Internet. Image forming devices have also become increasingly multifunctional, and a multi-function machine called a multifunction printer (hereinafter, a “printer”) transmits, as a client device, various types of data to a cloud server. A service provider provides services, in which data transmitted to such a server has been utilized, to a printer owner (hereinafter, a “user”). Here, examples of the provided services include a service of granting points to the user each time the user prints and a service of mailing replacement consumables to a user’s home when the user pays a fixed fee on a monthly basis. The user is registered with any of such provided services, and service registration information of the user is stored in a cloud service in association with the user and the printer. When a failure occurs in a printer such that continued use is difficult, the user replaces the printer with a new printer, and in such a case, the user desires to take the service registration information from the old printer to the new printer in a convenient manner. Japanese Unexamined Patent Application Publication No. 2008-288853 discloses a scheme for automatically executing a takeover process when an old device is replaced with a new device based on location information.

However, the scheme described in Japanese Unexamined Patent Application Publication No. 2008-288853 does not function well for printers. In the case of printers, services that can be registered may differ depending on models of the printer, and the services of a printer before replacement may not be able to be taken over by a printer after replacement.

### SUMMARY

Embodiments of the present disclosure facilitate takeover of services to a new network device.

A system according to an embodiment of the present disclosure is a system for taking over services with which a first network device is registered to a second network device, wherein the system provides a web page for supply of network devices on which a display according to registration of the first network device with the services is performed and whether to take over the services with which the first network device is registered is settable at the time of ordering the second network device; generates takeover information in which the second network device ordered via the web page, the first network device, and a takeover type according to a setting indicating whether to take over the services are associated, to cause the takeover information to be registered with each of the services with which the first network device is registered; notifies each service that can be provided to the second network device of registration of the second network device when the second network device has been registered in a management server; and in the service receiving the notification, executes takeover processing for the service based on the takeover information corresponding to the second network device.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of a network system.

FIG. 2 is a diagram illustrating a hardware configuration of a printer 100.

FIG. 3 is a diagram illustrating hardware configurations of a printer management server 200 and the like.

FIG. 4 is a diagram illustrating a software configuration of the printer 100.

FIG. 5 is a diagram illustrating a software configuration of the printer management server 200.

FIG. 6 is a diagram illustrating a software configuration of a service server 300.

FIG. 7 is a diagram illustrating a software configuration of a printer supply server 400.

FIG. 8 is a diagram illustrating a schema of a printer table.

FIGS. 9A and 9B are diagrams illustrating schemas of a registration information table and a takeover information table.

FIGS. 10A and 10B are diagrams illustrating schemas of a model table and an inventory table.

FIG. 11 is a sequence diagram up to display of a two-dimensional barcode on the printer 100.

FIG. 12 is a diagram illustrating a model selection screen of a printer supply EC site.

FIG. 13 is a diagram illustrating a purchase screen of the printer supply EC site.

FIG. 14 is a diagram illustrating a takeover type setup screen of the printer supply EC site.

FIG. 15 is a sequence diagram of a takeover information registration process after purchase confirmation in Embodiment 1.

FIG. 16 is a sequence diagram of service takeover processing for a new printer in Embodiment 1.

FIG. 17 is a diagram illustrating an example of a new service registration screen in Embodiment 2.

FIG. 18 is a sequence diagram of a takeover information registration process after purchase confirmation in Embodiment 2.

FIG. 19 is a sequence diagram of service takeover processing for a new printer in Embodiment 2.

### DESCRIPTION OF THE EMBODIMENTS

### Embodiment 1

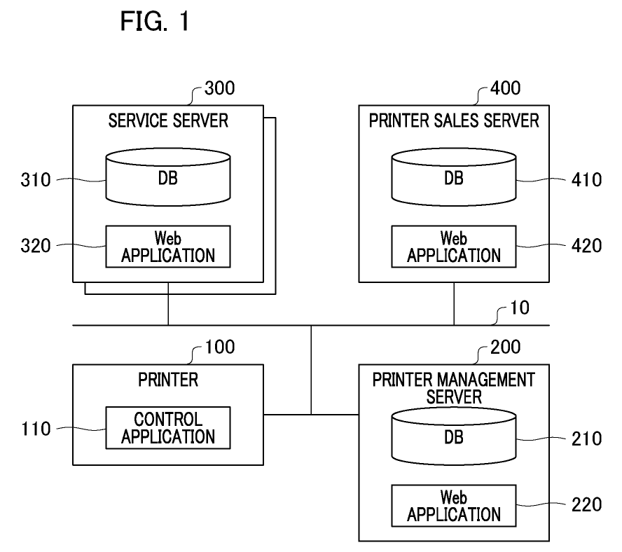

FIG. 1 is a diagram illustrating an overall configuration of a system. The system of the present embodiment automatically performs service takeover processing for a network device when the network device, such as a printer is updated, for example, by replacement. Specifically, when a severe error has occurred in a printer currently used by a user such that continued use is difficult, the system presents, to the user, access information (for example, a URL, a barcode that allows access to the URL, or the like) of a printer supply e-commerce (EC) site with takeover information. The user purchases a new printer on a printer supply EC site corresponding to the presented URL. The new printer purchased by the user is delivered to the user’s home, and when the user performs initial setup of the new printer, the system automatically executes the takeover processing.

The system includes a printer 100, which is a network device; a printer management server 200; a service server 300; and a printer supply server 400. The printer 100, the printer management server 200, the service server 300, and the printer supply server 400 are communicatively connected to each other via a network 10. The network 10 is, for example, the Internet. The network 10 may enable transmission and reception of data among the respective components of the system, and no limitation is imposed on a type or communication scheme. For example, the network 10 may be configured by any one or a combination of a LAN, a WAN, a cellular network such as LTE or 5G, a wireless network, a telephone line, a dedicated digital line, a frame relay line, a cable television line, and the like.

The printer 100 is an example of the network device in the present embodiment. The printer 100 is an image forming device having a printing function. The printer 100 is, for example, a printer, a copier, or a multifunction peripheral having a printing function. Using the printing function, the printer 100 receives print data (print job) via the network 10 and performs printing on actual paper or the like using known printing technology, such as electrophotographic technology or inkjet technology. The printing method is, for example, any of a laser beam printer employing an electrophotographic scheme, an inkjet printer employing an inkjet scheme, and a thermal transfer scheme. In the present embodiment, a case in which the network device is the printer 100 will be described as an example, but the present disclosure is not limited thereto. The network device may be any communicable device that supports services according to its model, and may be, for example, a scanner, a 3D printer, a notebook computer, a smartphone, or a smart home appliance.

The printer 100 includes a control application 110. The control application 110 includes a communication function via the network 10 and a function of controlling the printer 100. As the communication function via the network 10, the control application 110 includes two types of communication functions including an HTTPS communication function and an MQTT communication function. The HTTPS communication function is used when the printer 100 transmits, to the printer management server 200, the status information and the like. The MQTT communication function is used when the printer 100 receives a URL of an EC site with service registration information transmitted by the printer management server 200.

The printer management server 200 provides a service for managing the printer 100. The printer management server 200 is connected to the printer 100 and the service server 300 via the network 10. The printer management server 200 includes a database (DB) 210 and a web application 220. The DB 210 stores information of the printer 100 managed by the printer management server 200. For example, the DB 210 stores a printer identifier and status information of the printer 100. In the present embodiment, the printer identifier for uniquely identifying the printer is used as information for identifying the printer. The web application 220 receives, for example, the status information transmitted from the printer 100 and transmits the received information to the service server 300. Further, the web application 220 transmits, to the printer 100, the URL of the EC site with service registration information generated based on the service registration information received from the service server 300.

The service server 300 provides services related to printers. For example, the service server 300 manages the service registration information of the printer 100 or information of printers registered with the service. The service server 300 is connected to the printer 100, the printer management server 200, and the printer supply server 400 via the network 10. The service server 300 includes a DB 310 and a web application 320. The DB 310 stores information of services managed by the service server 300. For example, the DB 310 stores the printer identifier and user service registration information in association with the user identifier. The web application 320 returns, to the printer management server 200, the service registration information of the printer based on information stored in the DB 310. The service server 300 may be provided as an individual server for each service.

The printer supply server 400 provides an EC site for selling printers. The printer supply server 400 is connected to the service server 300 via the network 10. The printer supply server 400 includes a DB 410 and a web application 420. The DB 410 stores information of printers to be sold, which is to be displayed on the EC site. For example, the DB 410 stores model information and inventory information to be displayed on the EC site. The web application 420 transmits, to the service server 300, the takeover information to be described later in accordance with a printer purchase operation by a user.

In FIG. 1, each server (the printer management server 200, the service server 300, and the printer supply server 400) is illustrated as a single server, but the number of servers is not limited thereto. Each server may be configured by one or more elements. Each server may be realized by one or more information processing devices, a virtual machine (cloud service) using resources provided by a data center including information processing devices, or a combination thereof.

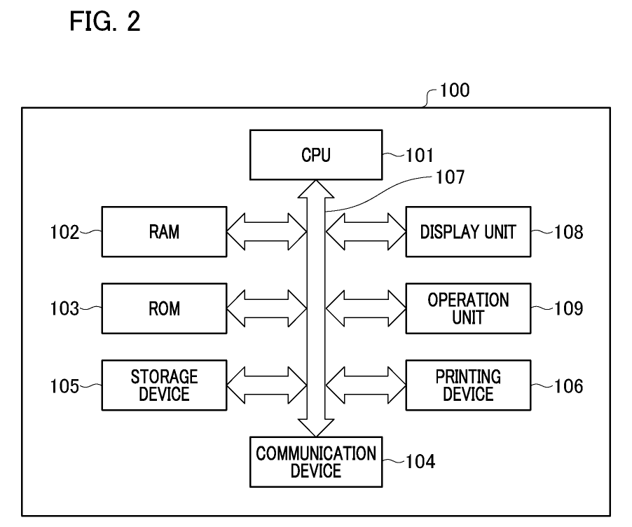

FIG. 2 is a diagram illustrating a hardware configuration of the printer 100. The printer 100 includes a CPU 101, a RAM 102, a ROM 103, a communication device 104, a storage device 105, a printing device 106, a display unit 108, and an operation unit 109. These components are connected to each other via a system bus 107. The system bus 107 exchanges data among the respective components in the printer 100.

The CPU 101 controls the entire printer 100. The RAM 102 is used as a temporary storage area when the CPU 101 executes various processes. The ROM 103 stores an operating system (OS), other application software (application programs), various types of data, and the like. Further, the ROM 103 may be a rewritable non-volatile memory, for example a flash memory. The storage device 105 is a large-capacity memory. The storage device 105 is, for example, a hard disk drive (HDD) or a solid state drive (SSD). The storage device 105 stores programs, such as application programs, printer driver programs, OS programs, control programs, or related programs, and various types of data. The storage device 105 also stores print data (job data). Further, the CPU 101 executes a program stored in a memory (for example, the ROM 103 or the storage device 105), thereby centrally controlling the respective components connected to the system bus 107 to control the printer 100.

The communication device 104 performs data communication with an external apparatus, such as the printer management server 200, via the network 10. The communication device 104 is, for example, an interface to which a LAN cable is connected. Data communication of the printer 100 may be performed wirelessly using a wireless interface. The display unit 108 displays various types of information. The display unit 108 includes, for example, a liquid crystal display (LCD). The operation unit 109 receives user input operations. The operation unit 109 includes, for example, buttons and a touch panel. Further, the display unit 108 and the operation unit 109 may be configured as an integrated touch panel. By associating input coordinates with display coordinates on the touch panel, a graphical user interface (GUI) can be configured such that the user can directly operate a screen displayed on the touch panel. The printing device 106 processes image data for printing to perform printing processing. For example, the printing device 106 processes job data received by the communication device 104 and performs printing on manuscript paper.

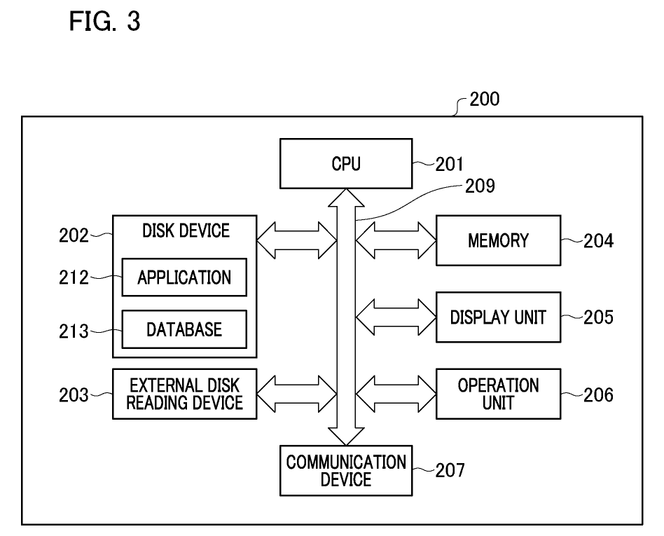

Next, hardware configurations of the respective servers (the printer management server 200, the service server 300, and the printer supply server 400) will be described with reference to FIG. 3. Here, as an example of a hardware configuration of the server, the printer management server 200 will be described by way of example. The service server 300 and the printer supply server 400 have configurations similar to that of the printer management server 200. FIG. 3 is a diagram illustrating a hardware configuration of the printer management server 200. The printer management server 200 includes a CPU 201, a disk device 202, an external disk reading device 203, a memory 204, a display unit 205, an operation unit 206, and a communication device 207. These components are connected to each other via a system bus 208. The system bus 208 exchanges data among the respective components in the printer management server 200.

The CPU 201 is a central processing unit for controlling the respective components of the printer management server 200. The disk device 202 stores an application program 212, a database 213, an OS program, and various files. The external disk reading device 203 is a device for reading information, such as files, stored in an external storage medium, such as an SD card. The memory 204 is used as a temporary storage area when the CPU 201 executes various processes. The memory 204 is configured by, for example, a RAM. In the memory 204, the CPU 201 performs temporary data storage, buffering, or the like as needed. The CPU 201 executes programs stored in a memory (for example, the disk device 202), thereby centrally controlling the respective components connected to the system bus 208 to control the printer management server 200.

The display unit 205 displays various types of information. The display unit 205 includes, for example, a liquid crystal display (LCD). The operation unit 206 receives user input operations. The operation unit 206 includes, for example, a keyboard and a mouse for allowing a user to perform various input operations. The communication device 207 is connected to the network 10 and performs various communications. The communication device 207 supports wired LAN or wireless LAN. The service server 300 and the printer supply server 400 may have hardware configurations different from that of the printer management server 200.

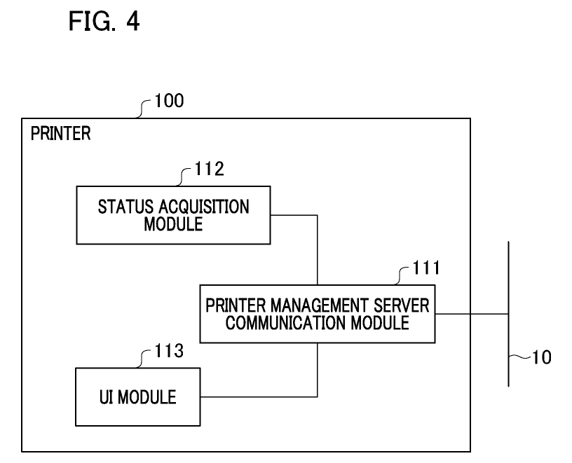

FIG. 4 is a diagram illustrating a software configuration of the printer 100. The software configuration of the printer 100 illustrated in FIG. 4 is realized by the CPU 101 of the printer 100 reading a program from a memory (for example, the ROM 103) and executing the program. The printer 100 includes a printer management server communication module 111, a status acquisition module 112, and a UI module 113. The printer management server communication module 111 is a module for performing communication with the printer management server 200 via the network 10. The printer management server communication module 111 transmits the status information generated by the status acquisition module 112, which will be described later, to the printer management server 200. Further, the printer management server communication module 111 receives a URL of the EC site with registration information from the printer management server 200.

The status acquisition module 112 is a module related to an operation regarding the status information of the printer 100. The status acquisition module 112 generates the status information based on information collected from various sensors of the printer when the user executes printing, scanning, or the like. The status information generated by the status acquisition module 112 is transmitted to the printer management server 200 via the printer management server communication module 111. The status information includes, for example, remaining amount information of ink installed in the printer 100 and information on an error that has occurred. Further, the error information included in the status information may include a severe error that cannot be resolved.

The UI module 113 displays, on the display unit 108, a URL of an EC site with registration information received from the printer management server 200 via the printer management server communication module 111 as a code image such as a two-dimensional barcode. The code image is a two-dimensional image that allows a web page corresponding to the access information to be displayed when the code image is read by a terminal or the like. A user reads the code image using a terminal such as a smartphone or a tablet. When the code image is read, a web page corresponding to the URL of the EC site with registration information is displayed on a web browser of the terminal. In the present embodiment, a case in which the URL of the EC site with registration information is displayed as a two-dimensional barcode will be described as an example, but a method of presenting the URL of the EC site with registration information to the user is not limited thereto. For example, a code image such as a QR code may be used. Further, the printer 100 may transmit the URL of the EC site with registration information received from the printer management server 200 to an email address registered as a notification destination or may notify a terminal registered as a notification destination of the URL using a push notification function.

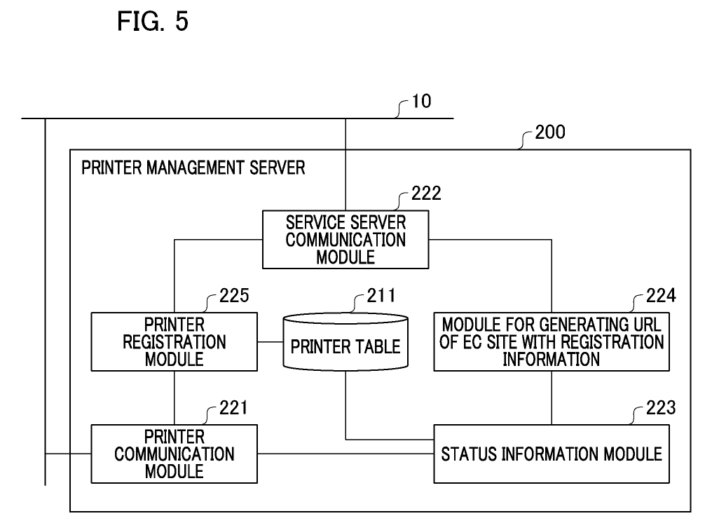

FIG. 5 is a diagram illustrating a software configuration of the printer management server 200. The software configuration of the printer management server 200 illustrated in FIG. 5 is realized by the CPU 201 of the printer management server 200 reading the program from the memory (for example, the disk device 202) and executing the program. The printer management server 200 includes a printer table 211, a printer communication module 221, a service server communication module 222, a status information module 223, a module for generating a URL of an EC site with registration information 224, and a printer registration module 225.

The printer table 211 is a database table for storing the status information and the like in association with the printer identifier. The printer communication module 221 is a module for performing communication with the printer 100. The printer communication module 221 transmits the status information received from the printer 100 to the status information module 223, which will be described later. The printer communication module 221 also transmits, to the printer management server communication module 111 of the printer 100, the URL of the EC site with registration information generated by the module for generating a URL of an EC site with registration information 224 to be described later. Further, the printer communication module 221 transmits a printer registration request received from the printer 100 to the printer registration module 225.

The service server communication module 222 is a module for performing communication with the service server 300. In response to a request from the module for generating a URL of an EC site with registration information 224, the service server communication module 222 transmits the printer identifier to the service server 300 and acquires a service registration status. Further, the service server communication module 222 transmits, to the service server 300, a printer registration notification request received from the printer registration module 225 and acquires a service registration status of the printer that is a registration request source.

The status information module 223 stores the status information received from the printer communication module 221 in the printer table 211. The status information module 223 detects whether the printer 100 is in a situation in which replacement of the printer 100 is recommended. For example, when a severe error that makes continued use impossible occurs in the printer 100, the status information module 223 determines that the printer 100 is in a situation in which replacement is recommended. When the status information module 223 determines that the printer 100 is in a situation in which replacement is recommended, the status information module 223 transmits the printer identifier of the printer 100 to the module for generating a URL of an EC site with registration information 224. In the present embodiment, when it is determined that continued use is impossible, the status information module 223 transmits the printer identifier of the printer 100 to the module for generating a URL of an EC site with registration information 224. In the present embodiment, a case in which a severe error that makes continued use impossible has occurred in the printer 100 as the situation in which replacement of the printer 100 is recommended has been described, but the present disclosure is not limited thereto. For example, a case in which a service life has elapsed, a case in which occurrence of a severe error that makes continued use impossible is predicted, a case in which some provided services are terminated, or a case in which a request for replacement of the printer 100 is received from the user may be determined to be a situation in which replacement is recommended.

When the module for generating a URL of an EC site with registration information 224 receives a request to generate the URL of the EC site with registration information, the module for generating a URL of an EC site with registration information 224 requests, via the service server communication module 222, each service server 300 to acquire registration information, and acquires service registration information. The module for generating a URL of an EC site with registration information 224 generates access information for the EC site with registration information (web page) based on the service registration information acquired from the service server 300 and a printer identification number. The EC site with registration information is a web page for printer supply (e.g., printer sales) on which whether or not to take over services with which the printer 100 is registered is settable at the time of purchase of the printer. In the present embodiment, a uniform resource locator (URL) for accessing the EC site with registration information is generated as the access information for the EC site with registration information. Hereinafter, the access information for the EC site with registration information generated by the module for generating a URL of an EC site with registration information 224 is referred to as a URL of the EC site with registration information. The EC site with registration information may be provided as a web-based application. When the printer registration module 225 receives the printer registration request from the printer communication module 221, the printer registration module 225 registers information in the printer table 211 and transmits the printer registration notification request to the service server communication module 222. The service server communication module 222 receiving the printer registration notification request transmits a printer registration notification to the service server 300 that provides services with which the registered printer is registerable. Accordingly, the service server communication module 222 and the printer registration module 225 function as notification means for notifying each service of the registration of the printer when the printer is registered in the printer management server 200.

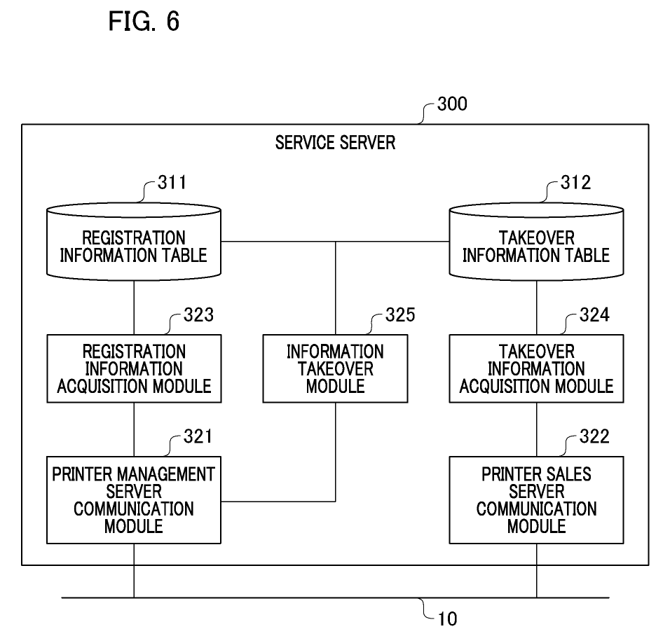

FIG. 6 is a diagram illustrating a software configuration of the service server 300. The software configuration of the service server 300 illustrated in FIG. 6 is realized by the CPU 201 of the service server 300 reading a program from a memory (for example, the disk device 202) and executing the program. The service server 300 includes a registration information table 311, a takeover information table 312, a printer management server communication module 321, a printer supply server communication module 322, and a registration information acquisition module 323. The service server 300 further includes a takeover information registration module 324 and an information takeover module 325.

The registration information table 311 manages information of printers registered with the service. The registration information table 311 is a database table for storing the printer identifier and the service registration information in association with the user identifier. The takeover information table 312 manages the takeover information used for the service takeover processing when a printer registered with the service is updated to a new printer. The takeover information table 312 is a database table for storing the takeover information in association with the user identifier. The printer management server communication module 321 is a module that performs communication with the printer management server 200.

When the printer management server communication module 321 receives, from the printer management server 200, a request for acquisition of registration information of a service associated with the printer identifier, the printer management server communication module 321 transmits the printer identifier to the registration information acquisition module 323. Further, when the printer management server communication module 321 receives the printer registration notification request from the printer management server 200, the printer management server communication module 321 transmits the printer identifier to the information takeover module 325.

The printer supply server communication module 322 is a module for performing communication with the printer supply server 400. When the printer supply server communication module 322 receives the takeover information from the printer supply server 400, the printer supply server communication module 322 transmits the takeover information to the takeover information registration module 324. When the registration information acquisition module 323 receives a service registration information acquisition request from the printer management server communication module 321, the registration information acquisition module 323 acquires the service registration information associated with the printer identifier included in the service registration information acquisition request with respect to the registration information table 311. The registration information acquisition module 323 returns the acquired service registration information to the printer management server communication module 321, thereby transmitting the service registration information to the printer management server 200 via the printer management server communication module 321.

The takeover information registration module 324 registers the takeover information received from the printer supply server 400 via the printer supply server communication module 322 in the takeover information table 312 in association with the user. The information takeover module 325 functions as takeover means that executes the service takeover processing based on takeover information associated with a printer for which registration has been notified, in response to the printer registration notification received from the printer management server 200.

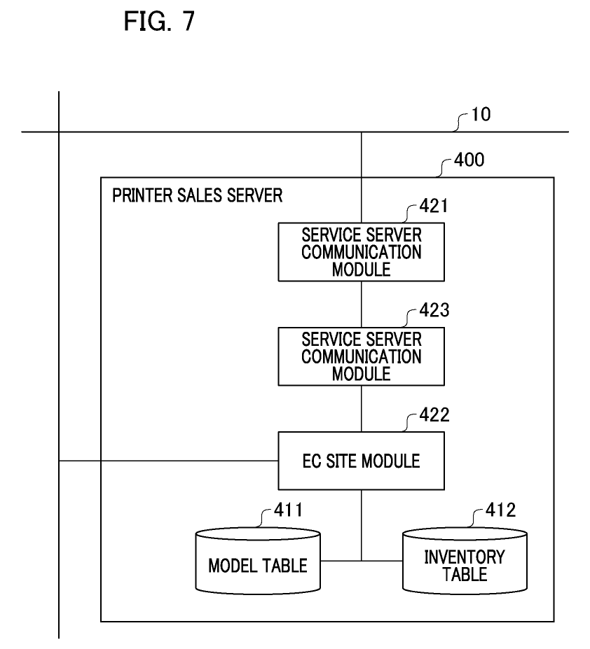

FIG. 7 is a diagram illustrating a software configuration of the printer supply server 400. The software configuration of the printer supply server 400 illustrated in FIG. 7 is realized by the CPU 201 of the printer supply server 400 reading the program from the memory (for example, the disk device 202) and executing the program. The printer supply server 400 includes a model table 411, an inventory table 412, a service server communication module 421, an EC site module 422, and a takeover information generation module 423.

The model table 411 stores product information to be displayed on the EC site and corresponding service information in association with the model identifier. The inventory table 412 stores the printer identifier in association with the model identifier. The service server communication module 421 is a module for performing communication with the service server 300. When the service server communication module 421 receives, as takeover information from the takeover information generation module 423 to be described later, an identifier of a takeover destination printer, an identifier of a takeover source printer, and information of a service to be taken over, the service server communication module 421 transmits the takeover information to the service server 300.

The EC site module 422 is a module related to an EC site accessed by the user via the URL of the EC site with service registration information. The EC site module 422 rewrites page content based on the service registration information which is supplementary information when a user accesses the EC site, the model table 411, and the inventory table 412, and generates and provides web pages that differ depending on the registration information. The EC site module 422 functions as web page providing means that provides, based on the service registration information, an EC site (web page) for printer supply (e.g., sales) on which whether to take over services with which the printer 100 is registered can be set at the time of purchase of the printer. Further, when the user performs a purchase operation on the EC site, the EC site module 422 determines, from the inventory table 412, a printer to be shipped to the user, and transmits the printer identifier of the determined printer to the takeover information generation module 423 together with the service registration information. When the EC site module 422 transmits the printer identifier to the takeover information generation module 423, the EC site module 422 also transmits, together with the printer identifier of the printer to be shipped (the takeover destination printer), information of a takeover type according to a user setting indicating whether to take over a service on the EC site. Accordingly, the EC site module 422 transmits, to the takeover information generation module 423, information of a takeover source printer and information of registered services based on the service registration information, information of a printer to be shipped (takeover destination printer), and information of the takeover type.

The takeover information generation module 423 receives, from the EC site module 422, the identifier of the takeover destination printer, an identifier of the printer 100, information of service for which a takeover type is set, and a takeover type according to a setting indicating whether to take over a service. The takeover information generation module 423 generates the takeover information for each service based on information received from the EC site module 422. The takeover information is information that is used in processing for taking over services of the printer that is a takeover source to the printer that is a takeover destination purchased via the EC site. The takeover information includes information of the takeover source printer, information of the takeover destination printer purchased via the EC site, and a takeover type according to a setting indicating whether to take over a service. The takeover information may include user information. The takeover information generated by the takeover information generation module 423 is transmitted, via the service server communication module 421, to the service server 300 that provides corresponding service, and is registered with each service. The takeover information generation module 423 functions as registration means that generates the takeover information and registers the takeover information in each service with which the printer 100 is registered.

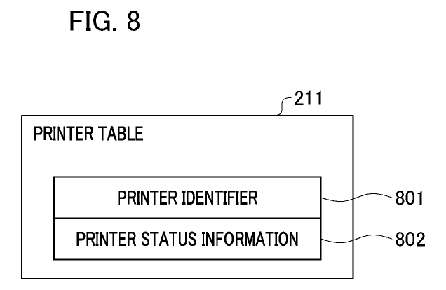

FIG. 8 is a diagram illustrating an example of the printer table 211. The printer table 211 is stored in the DB 210 of the printer management server 200. The printer table 211 stores a printer identifier 801 and the printer status information 802. Each item of the printer table 211 is created when the printer registration request reaches the printer management server 200 from the printer 100, with the printer identifier as a primary key. The printer identifier 801 is information for uniquely identifying a printer. Printer status information 802 is the status information of the printer. The printer status information 802 is updated when the status information reaches the printer management server 200 from the printer 100.

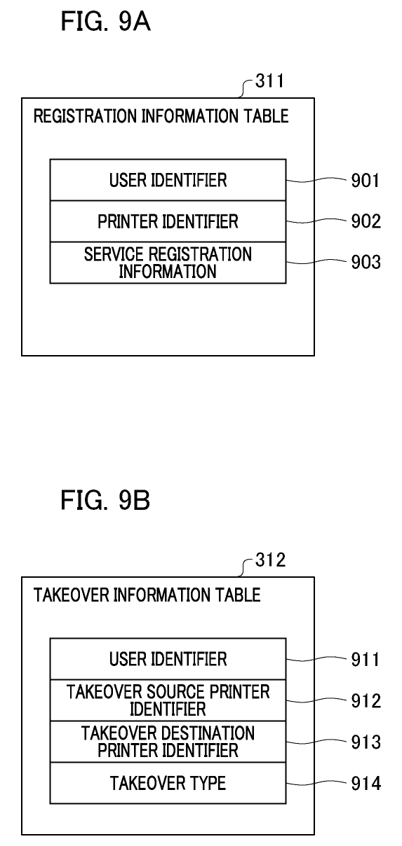

FIGS. 9A and 9B are diagrams illustrating examples of the registration information table 311 and the takeover information table 312. The registration information table 311 and the takeover information table 312 are stored in the DB 310 of the service server 300. FIG. 9A illustrates an example of the registration information table 311. The registration information table 311 stores a user identifier 901, a printer identifier 902, and service registration information 903.

The user identifier 901 is information for uniquely identifying a user. The printer identifier 902 is information for uniquely identifying a printer. The printer identifier 902 is the same as the printer identifier 801 managed by the printer management server 200. In the registration information table 311, the user identifier 901 and the printer identifier 902 constitute a composite primary key. The service registration information 903 is information related to a service, such as plan information or setting information of a service contracted by the user corresponding to the user identifier 901.

FIG. 9B illustrates an example of the takeover information table 312. The takeover information table 312 stores a user identifier 911, a takeover source printer identifier 912, a takeover destination printer identifier 913, and a takeover type 914. The user identifier 911 is information for uniquely identifying a user, and is the same as the user identifier 901 managed in the registration information table 311.

The takeover source printer identifier 912 is a printer identifier of a printer serving as a takeover source of a service. The takeover destination printer identifier 913 is a printer identifier of a printer serving as a takeover destination of the service. The takeover type 914 is information indicating whether to take over a service. In the present embodiment, the takeover type 914 has one of two values including “takeover” indicating that a service is to be taken over, and “withdrawal” indicating that a service is not to be taken over.

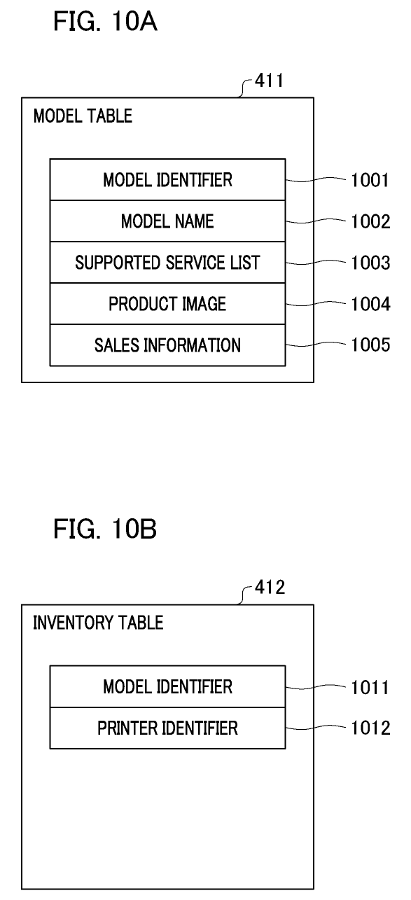

FIGS. 10A and 10B are diagrams illustrating examples of the model table 411 and the inventory table 412. The model table 411 and the inventory table 412 are stored in the DB 410 of the printer supply server 400. FIG. 10A illustrates an example of the model table 411. The model table 411 stores information for displaying products (printers) in EC site information. The model table 411 stores a model identifier 1001, a model name 1002, a supported service list 1003, a product image 1004, and supply information 1005. The model identifier 1001 is information for uniquely identifying a printer model. The model name 1002 is a name of the printer model. The supported service list 1003 is a list of services supported by the printer model. The product image 1004 is an image of the printer. The supply information 1005 is information such as a specification or features of the printer to be displayed on printer supply pages.

FIG. 10B illustrates an example of the inventory table 412. The inventory table 412 is used to manage inventory for each model. The inventory table 412 stores the model identifier 1011 and the printer identifier 1012. Specifically, the inventory table 412 stores printer identifiers 1012 of printers remaining as inventory in association with the model identifier 1011.

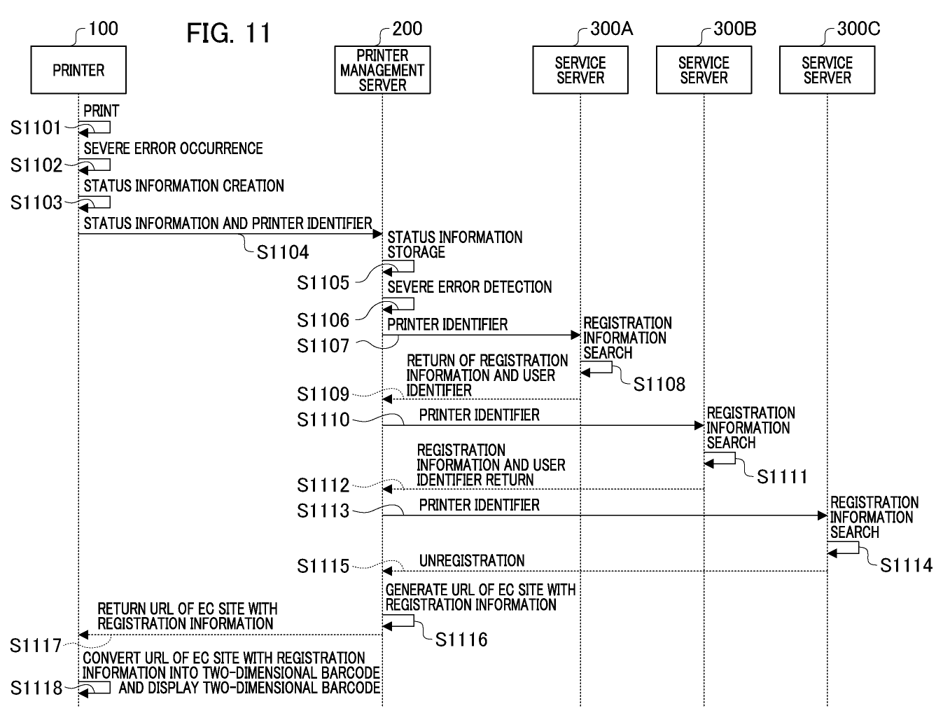

Next, processing in a system for taking over services with which a first network device is registered to a second network device will be described by taking a printer as an example. An example in which the system automatically executes the service takeover processing when an old printer (takeover source printer) is replaced with a new printer (takeover destination printer) will be described with reference to FIGS. 11-16. In the present embodiment, when a severe error or the like occurs in the printer 100 (takeover source printer) currently used by the user, a two-dimensional barcode for displaying an EC site with registration information is displayed on the printer 100. The user accesses the EC site with registration information from the two-dimensional barcode, performs a takeover setting, and purchases a new printer (takeover destination printer). When a purchased printer is delivered and the user performs setup settings, the takeover processing is automatically executed.

In the following description, when the user replaces a printer, a printer serving as a takeover source is referred to as a printer 100, and a new printer purchased by the user on the EC site with registration information, that is, a takeover destination printer, is referred to as a printer 120. A hardware configuration and a software configuration of the printer 120 are the same as those of the printer 100. Further, it is assumed that, as services related to printers, service A, service B, and service C are provided. A service server 300 corresponding to service A is denoted as a service server 300A, a service server 300 corresponding to service B is denoted as a service server 300B, and a service server 300 corresponding to service C is denoted as a service server 300C. It is assumed that a user of the printer 100 registers the printer 100 with service A and service B. It is also assumed that the user of the printer 100 does not register the printer 100 with service C. Hereinafter, components in the service server 300A, the service server 300B, and the service server 300C are denoted by adding suffixes A, B, and C, respectively. For example, the registration information table 311 in the service server 300A is denoted as a registration information table 311A.

The processes illustrated in FIGS. 11, 15, and 16 are executed by CPUs of any of the printer 100, the printer 120, the printer management server 200, and the service server 300A, the service server 300B, and the service server 300C. That is, a series of processes may be performed by CPUs of the respective devices executing program codes stored in memories of the respective devices. All or some of the processes illustrated in FIGS. 11, 15, and 16, may be realized by electronic circuits such as ASICs or by hardware.

First, processing up to displaying a two-dimensional barcode for displaying an EC site in order to replace the printer 100 with a new printer when an error occurs in the printer 100 will be described. In the system of the present embodiment, the two-dimensional barcode for displaying the EC site with registration information is displayed so that services with which the printer 100 in which an error has occurred is registered can be easily taken over by the printer 120 after purchase. FIG. 11 is a sequence diagram illustrating a process until the two-dimensional barcode is displayed on the printer 100.

In step S1101, the printing device 106 of the printer 100 starts printing in accordance with a user operation. In step S1102, the status acquisition module 112 detects that a severe error has occurred in the printer 100 based on sensor information collected in the printer 100. In step S1103, the status acquisition module 112 generates the status information indicating the severe error. In step S1104, the status acquisition module 112 transmits, to the printer management server 200 via the printer management server communication module 111, the status information generated in step S1103 and the printer identifier for uniquely identifying the printer 100.

In step S1104, the printer communication module 221 of the printer management server 200, which has received the status information and the printer identifier from the printer 100, transmits the status information and the printer identifier to the status information module 223. In step S1105, the status information module 223 updates an item of the printer table 211 based on the status information and the printer identifier received from the printer 100. Specifically, the status information module 223 updates the printer status information 802 associated with the printer identifier 801 in the printer table 211 that matches the printer identifier received from the printer 100, in accordance with the status information from the printer 100.

In step S1106, the status information module 223 detects whether the status information received from the printer 100 includes a severe error. When the status information module 223 detects that the status information received from the printer 100 includes the severe error, the status information module 223 transmits the printer identifier to the module for generating a URL of an EC site with registration information 224.

The module for generating a URL of an EC site with registration information 224 that has received the printer identifier queries the service server 300 of each service about the service registration information of the printer 100, and acquires the service registration information when the printer 100 is registered with the service. In the present embodiment, the module for generating a URL of an EC site with registration information 224 queries of the service servers 300A to 300C corresponding to services A to C about the service registration information of the printer 100. A printer identifier corresponding to the printer 100 is used for a request for the service registration information of the printer 100. Steps S1107 to S1115 are processes in which the module for generating a URL of an EC site with registration information 224 requests the service registration information of the printer 100 from each of the service servers 300A to 300C and acquires responses thereto.

First, in step S1107, the module for generating a URL of an EC site with registration information 224 of the printer management server 200 transmits the printer identifier to the service server 300A via the service server communication module 222. The module for generating a URL of an EC site with registration information 224 transmits the printer identifier of the printer 100, thereby querying whether the printer 100 corresponding to the printer identifier is registered with service A and requesting a response with registration information when the printer 100 is registered. In step S1108, the registration information acquisition module 323A of the service server 300A searches the registration information table 311A using the printer identifier received from the printer management server 200. When the printer identifier received from the printer management server 200 is registered in the registration information table 311A, the registration information acquisition module 323A acquires service registration information 903A corresponding to a printer identifier 902A. In step S1109, the registration information acquisition module 323A returns service registration information corresponding to the printer identifier of the printer 100 to the printer management server 200 that is a transmission source for the printer identifier via a printer management server communication module 321A.

Through the above processing, when the printer management server 200 has detected a situation in which the replacement of the printer 100 is recommended, the printer management server 200 acquires information of registration of the printer 100 with the service from each of the service servers 300 that can provide services to the printer 100. The printer management server 200 generates access information corresponding to a web page for printer supply to which the registration information has been assigned, and provides the access information to the printer 100. In the present embodiment, an example in which the printer management server 200 provides the access information to the printer 100 has been described, but the present disclosure is not limited thereto. For example, the printer management server 200 may transmit the generated access information to, for example, an email address registered as a contact address of a user or an administrator of the printer 100.

Next, in steps S1110 to S1112, the module for generating a URL of an EC site with registration information 224 performs the same processing as in steps S1107 to S1109 of the service server 300A on the service server 300B. In step S1110, the module for generating a URL of an EC site with registration information 224 of the printer management server 200 transmits the printer identifier to the service server 300B via the service server communication module 222. In step S1111, the registration information acquisition module 323B of the service server 300B searches a registration information table 311B using the printer identifier received from the printer management server 200 to acquire service registration information 903B corresponding to printer identifier 902B. In step S1112, the registration information acquisition module 323B returns service registration information corresponding to the printer identifier of the printer 100 to the printer management server 200 that is a transmission source for the printer identifier via the printer management server communication module 321B.

Next, in step S1113, the module for generating a URL of an EC site with registration information 224 of the printer management server 200 transmits the printer identifier to the service server 300C via the service server communication module 222. In the present embodiment, the printer 100 is registered with service A and service B, but is not registered with service C. Therefore, the printer identifier corresponding to the printer 100 is not registered in the registration information table 311C. In step S1114, the registration information acquisition module 323C of the service server 300C searches the registration information table 311C using the printer identifier received from the printer management server 200. As a result of the search, the registration information acquisition module 323C determines that there is no item associated with the printer identifier received from the printer management server 200 in the registration information table 311C. In step S1115, the registration information acquisition module 323B returns, to the printer management server 200 that is a transmission source for the printer identifier, information indicating that the printer 100 is not registered with service C via the printer management server communication module 321B. In the present embodiment, processing for requesting service registration information is performed in the order of service A to service C, but the present disclosure is not limited thereto and the processing for the respective services may be performed in parallel.

In step S1116, the module for generating a URL of an EC site with registration information 224 of the printer management server 200 generates access information for the EC site with registration information (a URL of an EC site with registration information) based on the service registration information of each service and a printer identification number. In step S1117, the module for generating a URL of an EC site with registration information 224 returns the generated access information for the EC site with registration information (a URL of an EC site with registration information) to the printer 100 via the printer communication module 221.

In step S1118, the printer 100 presents, to the user, a two-dimensional barcode corresponding to the access information for the EC site with registration information (a URL of an EC site with registration information) received from the printer management server 200 by displaying the two-dimensional barcode on the display unit 108. Specifically, the printer management server communication module 111 transmits the URL of the EC site with registration information received from the printer management server 200 to the UI module 113. The UI module 113 converts the URL of the EC site with registration information into a two-dimensional barcode and presents the two-dimensional barcode to the user. When the two-dimensional barcode is read by a user terminal or the like, the URL of the EC site with registration information corresponding to the two-dimensional barcode is accessed and the EC site with registration information is displayed.

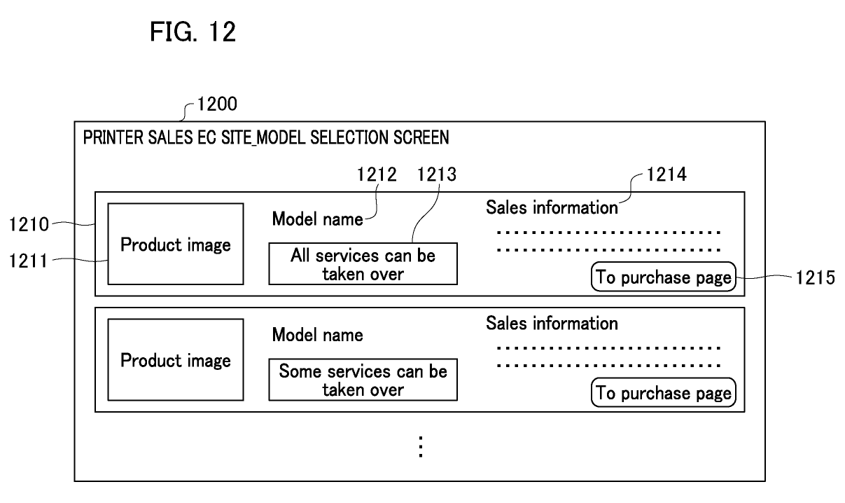

Next, a screen of the EC site accessed using the two-dimensional barcode by the user and a printer purchase operation after the takeover type is set will be described with reference to FIGS. 12-14. A screen of the EC site with registration information is rendered based on information in the model table 411 and the inventory table 412 and the service registration information by the EC site module 422 of the printer supply server 400.

FIG. 12 is a diagram illustrating an example of a model selection screen of the EC site. A printer supply EC site_model selection screen 1200 (hereinafter referred to as a “model selection screen 1200”) is a first screen (web page) accessed via a two-dimensional barcode corresponding to the URL of the EC site with registration information. On the model selection screen 1200, product information 1210 of sold printers is displayed in a list for each of models of the sold printers. Further, whether services with which the printer 100 is registered can be taken over for each sold printer model based on the registration information assigned to the URL is displayed on the model selection screen 1200. In each product information 1210, for example, a product image 1211, a model name 1212, a service takeover status 1213, supply information 1214, and a purchase screen transition button 1215 are displayed.

Information associated with the model identifier acquired from the model table 411 is displayed in the product image 1211, the model name 1212, and the supply information 1214. In the product image 1211, the product image 1004 acquired from the model table 411 is displayed. In the model name 1212, the model name 1002 acquired from the model table 411 is displayed. In the supply information 1214, the supply information 1005 acquired from the model table 411 is displayed.

In the service takeover status 1213, information based on comparison between the supported service list 1003 of the model table 411 and the service registration information of the printer 100 that is a takeover source. When all services included in the service registration information, that is, all services with which the printer 100 is registered, are included in the supported service list 1003, an indication that all services can be taken over is displayed in the service takeover status 1213. For example, a character string “All services can be taken over” is displayed in the service takeover status 1213. When only some of the services included in the service registration information are included in the supported service list 1003, an indication that some services can be taken over is displayed for the service takeover status 1213. That is, when some of the services included in the service registration information are not included in the supported service list 1003, an indication that some services can be taken over is displayed for the service takeover status 1213. For example, a character string “Some services can be taken over” is displayed in the service takeover status 1213. When none of the services included in the service registration information, that is, all services with which the printer 100 is registered, are not included in the supported service list 1003, an indication that none of the services can be taken over is displayed in the service takeover status 1213. For example, a character string “No services are supported” is displayed in the service takeover status 1213.

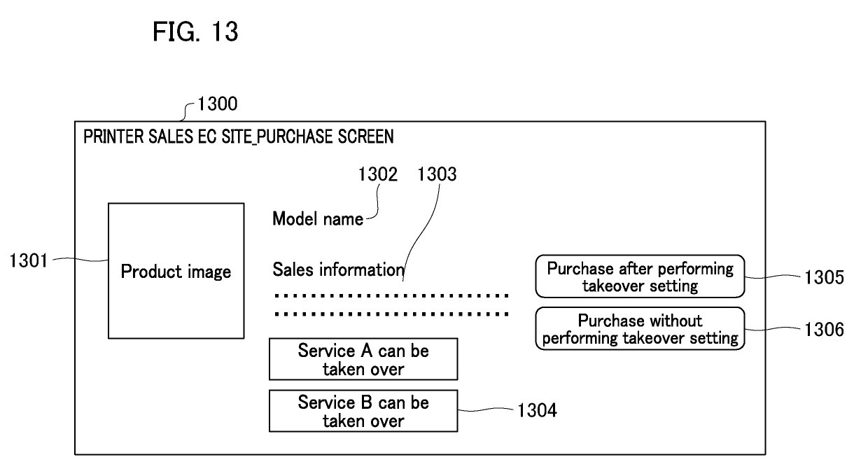

While checking, for example, the service takeover status 1213 indicated in the product information 1210, the user selects a model to be purchased from a list of the product information 1210 and presses the purchase screen transition button 1215 corresponding to the selected model (product). When it is detected that the purchase screen transition button 1215 has been pressed, the printer supply server 400 causes an EC site page displayed on the user terminal to transition to a purchase screen (FIG. 13) of the selected model. In the present embodiment, it is assumed that the product information 1210 in which “All services can be taken over” is displayed as the service takeover status 1213 on the model selection screen 1200 is selected.

FIG. 13 is a diagram illustrating an example of a purchase screen of the printer supply EC site. A printer supply EC site_purchase screen 1300 (hereinafter referred to as a “purchase screen 1300”) is a screen (web page) displayed when the purchase screen transition button 1215 displayed on the model selection screen 1200 is pressed. That is, the purchase screen 1300 is displayed when one of the printer models is selected on the model selection screen 1200. Whether the service can be taken over to the selected model for each service with which the printer 100 is registered and a button for transition to a setting screen for setting whether to take over the service (a takeover type setup screen transition button 1305) are displayed on the purchase screen 1300.

On the purchase screen 1300, a product image 1301, a model name 1302, supply information 1303, a service takeover status 1304, the takeover type setup screen transition button 1305, and a takeover type setup screen skip button 1306 are displayed. Further, a back button for returning to display of the model selection screen 1200 may be displayed on the purchase screen 1300. The same information as the product image 1211, the model name 1212, and the supply information 1214 of the model selection screen 1200 are displayed in the product image 1301, the model name 1302, and the supply information 1303.

Information indicating whether all services with which the printer 100 that is a takeover source is registered can be taken over, only some of the services can be taken over, or none of the services can be taken over is displayed on the model selection screen 1200, whereas whether the individual services can be taken over is displayed on the purchase screen 1300. The service takeover status 1304 indicates whether takeover is possible for each service to which the takeover source printer is registered. For example, in the case of the printer 100 registered with service A and service B, information indicating whether takeover is possible for service A and information indicating whether takeover is possible for service B are displayed in the service takeover status 1304.

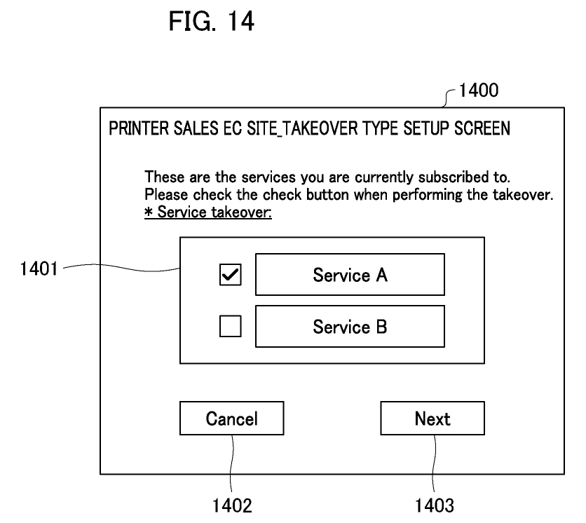

While checking the service takeover status 1304 and the like displayed on the purchase screen 1300, the user selects whether to take over services to the printer to be purchased and presses a corresponding purchase button. When the user takes over the services with which the printer 100 is registered to the printer to be purchased (printer 120), the user presses the takeover type setup screen transition button 1305. On the other hand, when the user does not take over the services with which the printer 100 is registered to the printer to be purchased (printer 120), the user presses the takeover type setup screen skip button 1306. When the takeover type setup screen skip button 1306 is pressed, no setting for taking over the services is performed, and thus, the screen transitions to a purchaser information input screen (not illustrated). On the other hand, when it is detected that the takeover type setup screen transition button 1305 has been pressed, the supply server 400 transitions the EC site page displayed on the user terminal to the takeover type setup screen (FIG. 14).

FIG. 14 is a diagram illustrating an example of a takeover type setup screen of the printer supply EC site. A printer supply EC site_takeover type setup screen 1400 (hereinafter referred to as a takeover type setup screen 1400) is a screen that is displayed by pressing the takeover type setup screen transition button 1305 displayed on the purchase screen 1300. The takeover type setup screen 1400 accepts a user setting as to whether to take over the service. On the takeover type setup screen 1400, a takeover service selection check box 1401, a cancel button 1402, and a next button 1403 are displayed.

In the takeover service selection check box 1401, a list of services passed as registration information is displayed together with check boxes. The takeover type setup is performed by the user performing a check operation on the check box. When the check box is checked, the takeover type of the service becomes “takeover.” On the other hand, when the check box is not checked, the takeover type of the service becomes “withdraw.” The user checks the check box for a service that the user wishes to take over to the printer to be purchased (printer 120) among the services with which the printer 100 is registered.

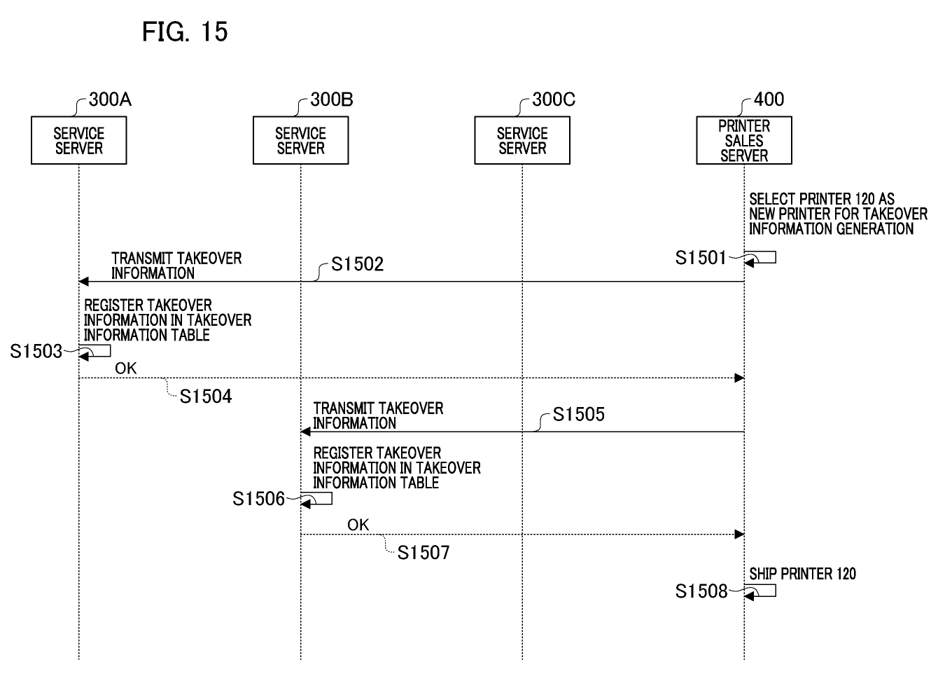

After the user selects whether or not to take over the services in the takeover service selection check box 1401, the user presses the next button 1403. When it is detected that the next button 1403 has been pressed, the supply server 400 stores takeover type setup information of the takeover service selection check box 1401 in a temporary storage place such as session storage, and then transitions to the purchaser information input screen (not illustrated). In the present embodiment, it is assumed that, in the takeover service selection check box 1401 of the takeover type setup screen 1400, the takeover type of service A is set to “takeover,” and the takeover type of service B is set to “withdraw.” On the purchaser information input screen (not illustrated), the user sets a user’s address and payment method, and presses a purchase confirmation button to confirm the purchase. When the pressing of the purchase confirmation button is detected, the printer supply server 400 starts a takeover process shown in FIG. 15. On the other hand, when the pressing of the cancel button 1402 is detected, the printer supply server 400 causes the EC site page displayed on the user terminal to transition to the purchase screen 1300 (FIG. 13).

A takeover process after the purchase confirmation button is pressed will be described with reference to FIG. 15. FIG. 15 is a sequence diagram of a takeover information registration process after purchase confirmation in Embodiment 1. The takeover information registration process shown in FIG. 15 is started when it is detected that the purchase confirmation button has been pressed after purchaser information is input on the purchaser information input screen. In S1501, the EC site module 422 of the printer supply server 400 selects a new printer purchased from the inventory and generates the takeover information. Specifically, first, when the EC site module 422 detects pressing of the purchase confirmation button, the EC site module 422 searches the inventory table 412 for inventory of the model selected by the user, and determines one unit of the inventory as a new printer (the printer 120). The EC site module 422 transmits, to the takeover information generation module 423, printer identification information of the printer 100, which is a takeover source, and the printer 120, which is a takeover destination, the service registration information of the printer 100, and a takeover type setup of each service selected by the user. The takeover information generation module 423 generates the takeover information for each service based on the received information. The takeover information generation module 423 generates the takeover information for each service with which the takeover source printer 100 is registered. The takeover information includes a takeover source printer identifier (the printer identifier of the printer 100), a takeover destination printer identifier (a printer identifier of the printer 120), and takeover type information (“takeover” or “withdraw”) of the service. For example, a case in which service A with which the printer 100 has been registered is taken over and service B is withdrawn as shown in the takeover type setup screen 1400 (FIG. 14) will be described. As the takeover information to be transmitted to service A, the takeover information generation module 423 generates the takeover information including the printer identifier of the printer 100, the printer identifier of the printer 120, and “takeover” as the takeover type information of the service. On the other hand, as the takeover information to be transmitted to service B, the takeover information generation module 423 generates the takeover information including the printer identifier of the printer 100, the printer identifier of the printer 120, and “withdraw” as the takeover type information of the service.

The takeover information generation module 423 that has generated the takeover information transmits the generated takeover information to each corresponding service server 300. First, a process of registering the takeover information with the service server 300A will be described. In S1502, the takeover information generation module 423 transmits the takeover information for service A to the service server 300A via the service server communication module 421. In S1503, the service server 300A registers the takeover information received from the printer supply server 400 in the takeover information table 312A. Specifically, the printer supply server communication module 322A of the service server 300A transmits the takeover information received from the printer supply server 400 to the takeover information registration module 324A. The takeover information registration module 324A registers, in the takeover information table 312A, the takeover information whose takeover type is “takeover.” In S1504, the takeover information registration module 324A returns a success (OK) of the processing to the printer supply server 400 via the printer supply server communication module 322A.

Next, a process of registering the takeover information in the service server 300B will be described. In S1505, the takeover information generation module 423 transmits the takeover information for service B to the service server 300B via the service server communication module 421. In S1506, the service server 300B registers the takeover information received from the printer supply server 400 in the takeover information table 312B. Specifically, the printer supply server communication module 322B of the service server 300B transmits the takeover information received from the printer supply server 400 to the takeover information registration module 324B. The takeover information registration module 324B registers, in the takeover information table 312B, the takeover information whose takeover type is “withdraw.” In S1507, the takeover information registration module 324B returns the success (OK) of the processing to the printer supply server 400 via the printer supply server communication module 322B.

When the transmission of the takeover information to all the service servers 300 for which a takeover type setup exists is completed, the EC site module 422 instructs processing of shipping the printer 120 in S1508. Through the above processing, when the printer 120 is purchased, the system registers, in the service server 300 that provides each service, information indicating whether each service with which the takeover source printer 100 is registered is to be taken over by the purchased printer 120 or is to be withdrawn.

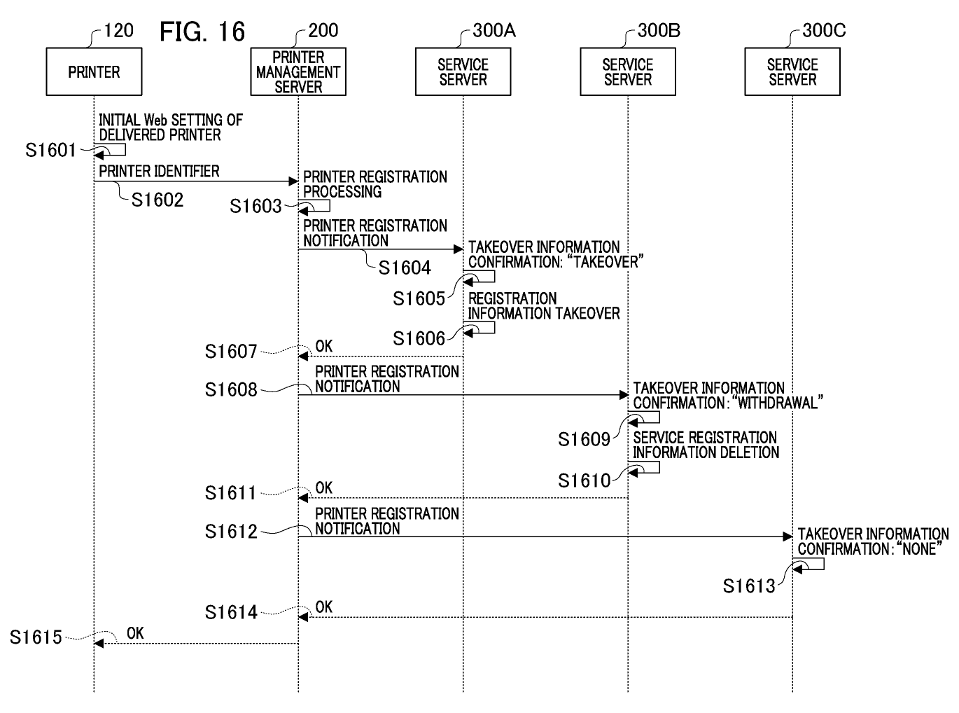

Next, processing performed when the printer 120 for which the shipping has been instructed in S1508 arrives at the user, is installed as a replacement for the printer 100, and setup is executed will be described. As part of the setup processing, the service takeover processing from the printer 100 that is a replacement source is executed and completed. FIG. 16 is a sequence diagram of the service takeover processing for a new printer in Embodiment 1. The processing of the service takeover to the new printer is executed as part of setup of the printer 120 newly purchased by the user after the printer 120 is mailed to the user.

In S1601, the printer 120 executes web initial setup representing an Internet connection setting and each permission setting based on a user operation. Accordingly, the printer 120 is connected to the network 10 so that the printer 120 can communicate with an external device such as the printer management server 200. In S1602, the printer 120 transmits a printer identifier to the printer management server 200 as the printer registration request.

In S1603, the printer management server 200 registers the printer identifier received from the printer 120 in the printer table 211. Specifically, first, the printer communication module 221 of the printer management server 200 that has received the printer identifier from the printer 120 transmits the printer identifier to the printer registration module 225. The printer registration module 225 that has received the printer identifier registers the printer identifier in the printer table 211.

Next, the printer registration module 225 performs the printer registration notification to each service server 300 that provides a service that can be provided to the printer 120, and processing in accordance with the takeover information is performed in each service server 300. First, processing regarding service A with which the printer 100 is registered and which is selected to be taken over will be described. In S1604, the printer registration module 225 transmits, as the printer registration notification, the printer identifier of the printer 120 to the service server 300A via the service server communication module 222.

In S1605, the service server 300A confirms the takeover information associated with the printer identifier of the printer 120 received from the printer management server 200. Specifically, first, the printer management server communication module 321A transmits the printer registration notification received from the printer management server 200 to an information takeover module 325A. The information takeover module 325A searches the takeover information table 312A for the takeover information associated with the printer identifier in the printer registration notification, and confirms the takeover type. In the present embodiment, the takeover type of service A from the printer 100 to the printer 120 is “takeover.” Therefore, the information takeover module 325A confirms that the takeover type is “takeover.”

In S1606, takeover processing is executed as processing in a case in which the takeover type is “take over.” Therefore, in S1606, the information takeover module 325A executes processing for taking over registration information with respect to the registration information table 311A. Specifically, the information takeover module 325A executes takeover processing for deleting the registration information associated with the takeover source printer identifier and registering equivalent data using the takeover destination printer identifier. When the information takeover module 325A completes the takeover processing, the information takeover module 325A performs processing of S1607. In S1607, the information takeover module 325A returns completion (for example, OK) of the printer registration processing to the printer management server 200 via the printer management server communication module 321A.

Next, processing regarding service B with which the printer 100 is registered and which is selected not to be taken over will be described. In S1608, the printer registration module 225 transmits, as the printer registration notification, the printer identifier of the printer 120 to the service server 300B via the service server communication module 222.

In S1609, the service server 300B confirms the takeover information associated with the printer identifier of the printer 120 received from the printer management server 200. Specifically, first, the printer management server communication module 321B transmits the printer registration notification received from the printer management server 200 to the information takeover module 325B. The information takeover module 325B searches the takeover information table 312B for the takeover information associated with the printer identifier in the printer registration notification to confirm the takeover type. In the present embodiment, the takeover type of service B from the printer 100 to the printer 120 is “withdraw.” Therefore, the information takeover module 325B confirms that the takeover type is “withdraw.”

In S1610, processing for deleting the registration information is executed as processing in a case in which the takeover type is “withdraw.” Therefore, in S1610, the information takeover module 325B executes the processing for deleting the registration information with respect to the registration information table 311B. Specifically, the information takeover module 325B deletes the registration information associated with the takeover source printer identifier. When the information takeover module 325B completes processing for deleting the registration information, the information takeover module 325B performs processing of S1611. In S1611, the information takeover module 325B returns the completion (for example, OK) of the printer registration processing to the printer management server 200 via the printer management server communication module 321B. The information takeover module 325B may return, to the printer management server 200, information indicating that the processing for deleting the registration information has been completed and the service has been withdrawn.

Next, processing regarding service C with which the printer 100 is not registered will be described. In S1612, the printer registration module 225 transmits, as the printer registration notification, the printer identifier of the printer 120 to the service server 300C via the service server communication module 222.

In S1613, the service server 300C confirms the takeover information associated with the printer identifier of the printer 120 received from the printer management server 200. Specifically, first, the printer management server communication module 321C transmits the printer registration notification received from the printer management server 200 to an information takeover module 325C. The information takeover module 325C searches the takeover information table 312B for the takeover information associated with the printer identifier in the printer registration notification. In the present embodiment, there is no takeover information of service C from the printer 100 not registered with service C to the printer 120. Therefore, the information takeover module 325B confirms that there is no takeover information. In S1614, the information takeover module 325C returns the completion (for example, OK) of the printer registration processing to the printer management server 200 via the printer management server communication module 321C. The information takeover module 325C may return, to the printer management server 200, information indicating that registration information does not exist and that the printer is not registered with the service.

The printer registration module 225, which has performed registration notification to each of all service servers 300 with which the printer 120 is registerable and has received OK as a response thereto, performs processing of S1615. In S1615, the printer registration module 225 returns OK to the printer 120 via the printer communication module 221 as a response to the printer registration request in S1602.

Through the above processing, in each service that has received the printer registration notification, processing according to the takeover type in the takeover information is executed. When the takeover type indicates that the service is taken over, the service server 300 performs processing for taking over the service provided to the printer 100 to the printer 120. In service takeover, the printer 120 is registered with the service, the registration information of the printer 100 associated with the printer 120 in the takeover information is registered in registration information of the printer 120, and the registration information of the printer 100 is deleted. When the takeover type indicates withdrawal from the service, the service server 300 deletes the registration information associated with the printer 100 registered with the service, thereby withdrawing (canceling) the service used with the printer 100 during the start of use of the printer 120.

As described above, according to the present embodiment, the failure of the printer can be detected by the server, and a printer purchase site that takes into account differences in services with which the printer can be registered depending on models can be presented to the user. Further, when a printer is purchased at the printer purchase site, it is possible to set whether to take over, to the purchased printer, services with which the failed takeover source printer has been registered. When the new purchased printer is set up, service takeover processing based on the takeover information generated during purchase is automatically executed, thereby realizing service takeover from the failed printer to the new printer in a convenient manner for the user.

### Embodiment 2

In Embodiment 1, a flow of performing a takeover setting for services with which an old printer is registered has been described. In Embodiment 2, in addition to the takeover setting for the services with which the printer has been registered as in Embodiment 1, recommendation of new service registration is performed, and processing according to whether the user selects necessity of recommended service registration is also performed. Hereinafter, only differences from Embodiment 1 will be described. In Embodiment 2, a value “new” indicating newly registering with a service is added to the takeover type 914 of the takeover information table 312 (FIG. 9B), in addition to “takeover” and “withdraw.”

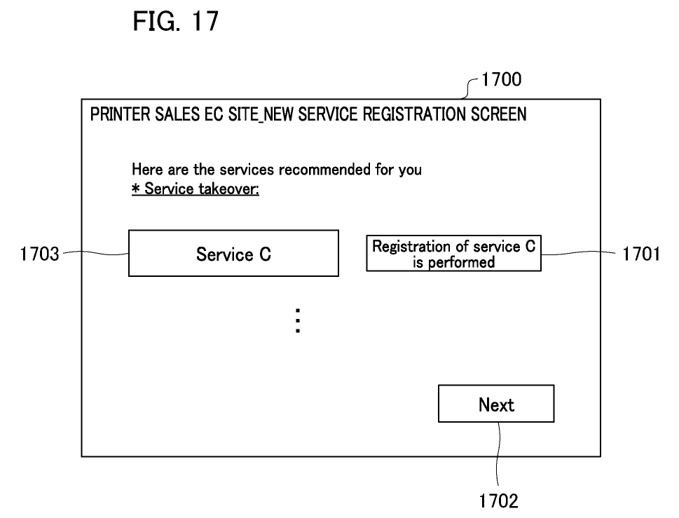

In Embodiment 1, when the next button 1403 on the takeover type setup screen 1400 is pressed, the screen transitions to the purchaser information input screen (not illustrated), but in the present embodiment, the screen transitions to a screen for new service registration to be recommended. An example of the screen for new service registration recommended in the present embodiment is shown in FIG. 17. FIG. 17 is a diagram illustrating an example of the new service registration screen in Embodiment 2. The screen shown in FIG. 17 is rendered by the EC site module 422 of the printer supply server 400 based on model information of the printer 120 selected for purchase and the service registration information of the printer 100.

A new printer supply EC site_service registration screen 1700 (hereinafter referred to as a new service registration screen 1700) is a screen that is displayed by pressing the next button 1403 displayed on the takeover type setup screen 1400. The new service registration screen 1700 is a registration screen for setting new registration of a service with which the printer 100 is not registered and the printer 120 is registerable, which is displayed after a takeover setting for services with which the printer 100 is registered is performed. On the new service registration screen 1700, a service list 1703, a service registration screen transition button 1701, and a next button 1702 are displayed.

In the service list 1703, services recommended for new registration are displayed as a list. Specifically, in the service list 1703, a list of services not registered by the user is displayed based on the registration information and a corresponding service list of the model table 411. Further, the service registration screen transition button 1701 for transitioning to a service registration screen for each service displayed in the service list 1703 is displayed.

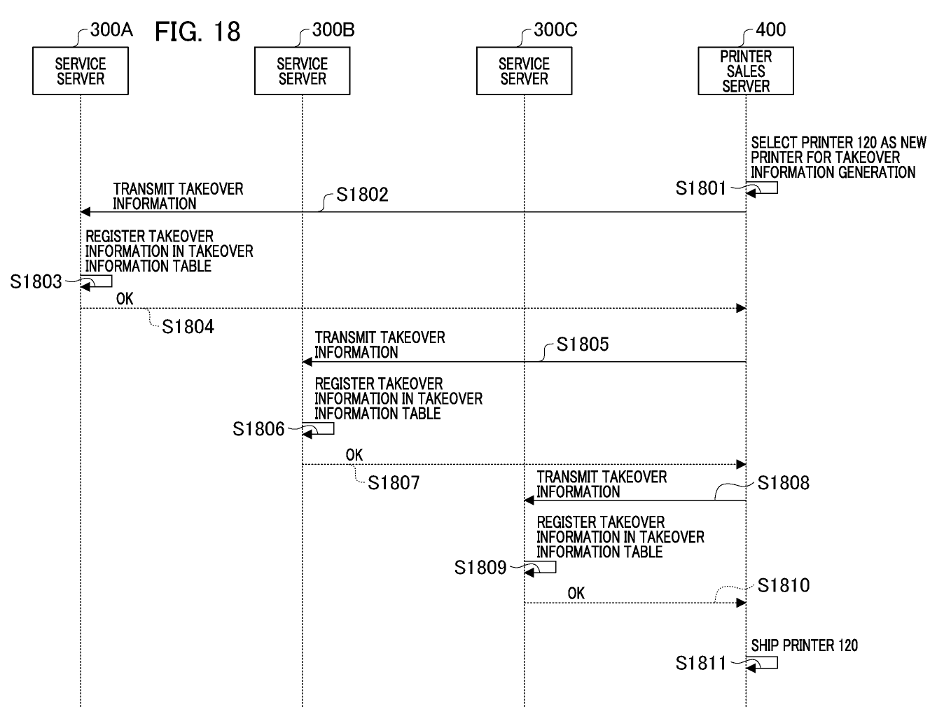

When pressing of the service registration screen transition button 1701 by the user is detected, the printer supply server 400 transitions to the service registration screen. On the service registration screen, necessary information can be entered and new service registration can be performed. When the service registration is performed, the takeover information is stored in a temporary area with the takeover type “new.” When pressing of the next button 1702 is detected, the printer supply server 400 transitions to the purchaser information input screen (not illustrated). Similarly to Embodiment 1, when the user inputs necessary information on the purchaser information input screen and presses the purchase confirmation button, the takeover processing of FIG. 18 is started.

FIG. 18 is a sequence diagram of the takeover information registration processing after purchase confirmation in Embodiment 2. Here, only differences from the takeover information registration processing (FIG. 15) of Embodiment 1 will be described. Hereinafter, a case in which registration of service C has been newly performed when the printer 120 is purchased will be described. In Embodiment 1, the takeover information of service C did not exist, but in Embodiment 2, the takeover information of service C exists. Therefore, similarly to the service server 300A and the service server 300B, the takeover information is also transmitted to the service server 300C. Processing of S1801 to S1807 is the same as processing of S1501 to S1507 shown in FIG. 15.

In S1808, the takeover information generation module 423 transmits the takeover information for service C to the service server 300C via the service server communication module 421. In S1809, the service server 300C registers the takeover information received from the printer supply server 400 in the takeover information table 312C. Specifically, the printer supply server communication module 322C of the service server 300C transmits the takeover information received from the printer supply server 400 to the takeover information registration module 324C. The takeover information registration module 324B registers the takeover information whose takeover type is “new” in the takeover information table 312C. In S1810, the takeover information registration module 324C returns the success (OK) of the processing to the printer supply server 400 via the printer supply server communication module 322C. Processing of step S1811 is the same as processing of S1508 (FIG. 15) in Embodiment 1.

Through the above processing, when new registration of a service is performed, the printer supply server 400 generates takeover information in which the printer 120, registration information for the newly registered service, and a takeover type indicating new registration are associated. The printer supply server 400 can cause the takeover information to be registered in the newly registered service.

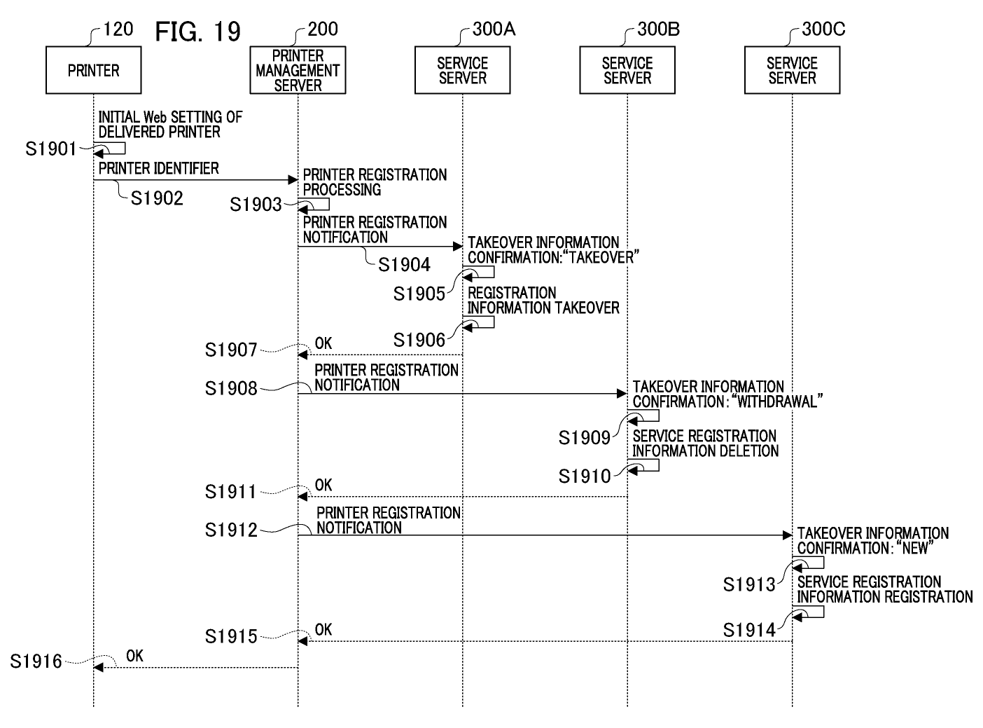

FIG. 19 is a sequence diagram of the service takeover processing for a new printer in Embodiment 2. Hereinafter, only differences from the service takeover processing (FIG. 16) in Embodiment 1 will be described. S1901 to S1912 are the same as S1601 to S1612 in Embodiment 1. In Embodiment 1, since there was no takeover information registration in the takeover information table 312C, takeover processing (registration processing) of the printer 120 for service C was not performed in service server 300C. On the other hand, in the present embodiment, the takeover information registration exists in the takeover information table 312C. Therefore, in S1913, the service server 300C confirms the takeover information associated with the printer identifier of the printer 120 received from the printer management server 200.

Specifically, first, in S1913, the printer management server communication module 321C transmits the printer registration notification of the printer 120 received from the printer management server 200 to the information takeover module 325C. The information takeover module 325C searches the takeover information table 312C for the takeover information associated with the printer identifier in the printer registration notification to confirm the takeover type. In the present embodiment, the takeover type of the takeover information associated with the printer identifier of the printer 120 is “new.” Therefore, the information takeover module 325C confirms that the takeover type is “new.”

In S1913, new registration processing is executed as takeover processing when the takeover type is “new”. Therefore, in S1914, the information takeover module 325A registers the takeover information with takeover type “new.” Specifically, the information takeover module 325C executes the new registration processing for the registration information using the printer identifier of the printer 120 with respect to the registration information table 311C. When the information takeover module 325C completes the new registration processing, the information takeover module 325C performs processing of S1915. In S1915, the information takeover module 325C returns the completion (for example, OK) of the printer registration processing to the printer management server 200 via the printer management server communication module 321C. Processing of S1916 is the same as processing of S1615 in Embodiment 1.

Through the above processing, in the service that has received the notification, the takeover information associated with the printer 120 whose registration has been notified is confirmed, and when the takeover type indicates new registration, the printer 120 is newly registered with the service.

As described above, according to the present embodiment, when a new printer is purchased, services with which a takeover source printer has not been registered can be displayed such that the services can be selected, and services can be added according to a user’s selection. Takeover information is also generated for the added services, and when a new purchased printer is set up, service takeover processing based on the takeover information is automatically executed. Accordingly, it is possible to realize, for the user, service takeover from a takeover source printer to a new printer and addition of services using a convenient method.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-074859, which was filed on Apr.28, 2025 and which is hereby incorporated by reference wherein in its entirety.

What is claimed is:

1. A system for taking over services with which a first network device is registered to a second network device, the system comprising:
a supply server configured to supply the network devices, and a management server configured to provide a service for managing the network devices,
wherein the supply server comprises:
a first memory storing instructions; and
a first processor executing the instructions to cause the supply server to:
provide a web page for supply of network devices on which a display according to registration of the first network device with the services is performed and whether to take over the services with which the first network device is registered is settable at the time of ordering the second network device; and
generate takeover information in which the second network device ordered via the web page, the first network device, and a takeover type according to a setting indicating whether to take over the services are associated, to cause the takeover information to be registered with each of the services with which the first network device is registered,
wherein the management server comprises:
a second memory storing instructions; and
a second processor executing the instructions to cause the management server to:
notify each service capable of being provided to the second network device of registration of the second network device when the second network device has been registered in the management server,
wherein in the service receiving the notification, takeover processing for the service is executed based on the takeover information corresponding to the second network device.

2. The system according to claim 1, wherein the second processor further executes instructions to cause the management server to:
acquire, from each service capable of being provided to the first network device, information related to registration of the first network device with the service when the management server has detected a situation in which replacement of the first network device is recommended; and
generate and provide access information corresponding to a web page for supply of the network devices to which the registration information is assigned,
wherein whether to take over the services with which the first network device is registered to each ordered network device is displayed on the web page corresponding to the access information.

3. The system according to claim 2, wherein the second processor of the management server provides the access information to the first network device, and the first network device generates and displays a code image allowing the web page corresponding to the access information to be displayed when the code image is read.

4. The system according to claim 1, wherein when one model of a network device is selected on the web page, a order screen is displayed, and whether each service with which the first network device is registered can be taken over by the model and a button for transition to a setting screen for setting whether to take over the service are displayed on the order screen, and
a user setting for whether to take over the services is received on the setting screen.

5. The system according to claim 1,
wherein in the service, the first network device registered with the service, information on a user of the first network device, and information on the service are managed as registration information in association with each other,
wherein when the takeover information is received, the takeover information and the information on the user associated with the first network device included in the takeover information are managed in association with each other in the service, and
wherein the takeover information associated with the second network device whose registration has been notified is confirmed in the service when the notification is received, the service provided to the first network device is taken over by the second network device when the takeover type indicates taking over the service, and the registration information associated with the first network device registered with the service is deleted when the takeover type indicates withdrawing from the service.

6. The system according to claim 5, wherein in takeover of the service from the first network device in the service to the second network device, the second network device is registered with the service, the registration information of the first network device associated with the second network device in the takeover information is registered as registration information of the second network device, and the registration information of the first network device is deleted.

7. The system according to claim 1,
wherein, after a takeover setting for services with which the first network device is registered is performed, the first processor of the supply server provides a registration screen for setting new registration of a service with which the first network device is not registered and the second network device is registerable,
wherein when the new registration is performed, the first processor of the supply server generates takeover information in which the second network device and a takeover type indicating new registration are associated with each other, and registers the takeover information with the newly registered service, and
wherein in the service, the takeover information associated with the second network device whose registration has been notified is confirmed when the notification has been received, and the second network device is registered with the service when the takeover type indicates new registration.

8. The system according to claim 1, wherein the second network device is an image forming device having a printing function.

9. A control method for a system for taking over services with which a first network device is registered to a second network device, the control method comprising:
providing a web page for supply of network devices on which a display according to registration of the first network device with the services is performed and whether to take over the services with which the first network device is registered is settable at the time of ordering the second network device;
generating takeover information in which the second network device ordered via the web page, the first network device, and a takeover type according to a setting indicating whether to take over the services are associated, to cause the takeover information to be registered with each of the services with which the first network device is registered;
notifying each service capable of being provided to the second network device of registration of the second network device when the second network device has been registered in a management server; and
in the service receiving the notification, executing takeover processing for the service based on the takeover information corresponding to the second network device.
